(19) United States
(12) Patent Application Publication
(10) Pub. No.: US 2006/0133372 A1
(43) Pub. Date: Jun. 22, 2006

(54) Apparatus and method for multiplexing packet in mobile communication network

(75) Inventors: Dong Jo Cheong, Yongin-si (KR); Kyung Sub Seo, Sungnam-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/260,687

(22) Filed: Oct. 28, 2005

(30) Foreign Application Priority Data
Oct. 29, 2004 (KR) 10-2004-0087522

(51) Int. Cl. H04L 12/56; H04J 3/04

(52) U.S. Cl. 370/389; 370/535; 370/401

(57) ABSTRACT

A multiplexing apparatus and method for reducing packet overhead in a mobile communication network are provided, which can enhance efficiency of a transmission section by performing multiplexing in an application layer and then reducing header quantity of the packet. The method includes the steps of transmitting, at a sending terminal and a receiving terminal, SDP including information on a quantity of transmission data to be multiplexed and then establishing a session, collecting the quantity of transmission data when the transmission data is generated, adding a header to the transmission data, and then multiplexing the transmission data and the header, and then transmitting the packet multiplexed through the established session. In doing so, embodiments of the present invention reduce the fundamentally generated header, whereby transmission overhead in the transmission section of the network can be minimized and efficiency of the transmission section of a wireless network can be maximized.

### CROSS-REFERENCE TO RELATED APPLICATIONS

This application claims the benefit under 35 U.S.C. §119(a) of Korean Patent Application No. 10-2004-0087522 for “APPARATUS AND METHOD FOR MULTIPLEXING PACKET IN MOBILE COMMUNICATION NETWORK”, filed in the Korean Intellectual Property Office on Oct. 29, 2004, the entire disclosure of which is hereby incorporated by reference.

### BACKGROUND OF THE INVENTION

1. Field of the Invention:

The present invention relates to a multiplexing apparatus and method for reducing packet overhead in a mobile communication network.

2. Description of the Related Art:

Early communication networks that provided voice service have recently been reconfigured to provide data service as well. While early network configurations actually were capable of providing both voice service and data service, as demand for data service gradually increased, a separate data network for providing data service was configured. This new configuration substantially replaced the stagnant voice service. Further, in line with the spread and development of the Internet, the speed of data service has come to surpass that of voice service, and this trend continues to attract investment in data networks.

Early mobile communication networks, whose main service was voice service, have also evolved into a new configuration in which data service is also important. A current trend in mobile communication network development is provision of a wireless channel configuration for data service. According to this trend, a time will come when a data network includes a voice network in mobile communications as well as in wired communications. To this end, it is necessary to support voice service via a data network.

Voice over IP (VoIP) has been introduced to support voice service via a data network. However, there is considerable overhead compared to the amount of VoIP packet data transmitted and thus, the efficiency of the mobile communication network in the wireless region deteriorates. Considering that the most expensive part of the mobile communication network is the wireless region, such packet overhead is a serious problem that requires a solution. Existing methods of reducing packet overhead include header compression, multiplexing, and other such techniques.

In the following discussion, packet multiplexing will be particularly considered as an example.

Multiplexing is a method of reducing overhead by transmitting various data in a header. Various multiplexing methods have been suggested on the basis of a layer, including Point-to-Point Protocol mux (PPPmux), Composite IP (CIP), and Lightweight IP Encapsulation (LIPE), for example. These multiplexing methods will now be described in greater detail with reference to the accompanying drawings. First, a PPPmux multiplexing method will be described in greater detail.

FIG. 1 is a diagram of PPPmux multiplexing method. Referring to FIG. 1, a mobile communication network is comprised of a terminal 100, an access network 120, a Packet Data Switched Network (PDSN) 130, an IP network 150, and a Correspond Node (CN) 160. The PPPmux is embodied in a multiplexing method performed between the terminal 100 and the PDSN 130, as indicated by reference numeral 101. The PPPmux is a technique by which a plurality of Internet Protocol/User Datagram Protocol/Real Time Protocol (IP/UDP/RTP) packets are transmitted between the terminal 100 and the PDSN 130 using one Point-to-Point Protocol header so that PPP overhead can be reduced. FIG. 1 also shows a protocol stack based on PPPmux. As shown in FIG. 1, in PPPmux, the PDSN 130 and the terminal 100 multiplex the IP/UDP/RTP packets using PPPmux protocols 138 and 110, respectively.

When using PPPmux, the terminal 100 and the PDSN 130 require as many buffering functions as the number of voice frames requiring multiplexing. Accordingly, there is a problem in an existing system in that a configuration change is needed to accept PPPmux.

Next, Composite IP (CIP) and Lightweight IP Encapsulation (LIPE) multiplexing methods will be described in greater detail.

FIG. 2 is a diagram of CIP or LIPE multiplexing methods. The CIP and LIPE multiplexing methods are techniques for performing multiplexing in an RTP level. That is, in CIP and LIPE, six RTP packets are transmitted using one UDP/IP header. Unlike PPPmux, CIP and LIPE are performed between the terminal 100 and the CN 160. Since CIP and LIPE can reduce the IP/UDP header, it can be said that they are more efficient than PPPmux. FIG. 2 also shows a protocol stack based on CIP or LIPE.

The multiplexing methods described above are used to reduce the amount of transmission data in the mobile communication network. However, transmission resources of the mobile communication network can be used more efficiently if the amount of transmission data is further reduced.

Accordingly, a need exists for a method and apparatus for further reducing packet overhead in a mobile communication network.

### SUMMARY OF THE INVENTION

It is an object of the present invention to substantially solve the above and other problems, and to provide a multiplexing apparatus and method for reducing packet overhead in a mobile communication network.

It is another object of the present invention to provide a multiplexing apparatus and method for reducing VoIP packet overhead in a mobile communication network.

It is yet another object of the present invention to provide a multiplexing apparatus and method for performing multiplexing without adding a separate process to an existing packet transmission process.

According to an aspect of the present invention, a network multiplexing apparatus used in packet transmission through a network is provided comprising a data collector for collecting a predetermined quantity of transmission data when the transmission data is generated, and a packet generator for adding a header including transmission information into the predetermined quantity of transmission data and generating a packet to be transmitted through the network.

According to another aspect of the present invention, a multiplexing method used in packet transmission through a network is provided comprising a first step of transmitting, at a sending terminal and a receiving terminal, SDP including information on a quantity of transmission data to be multiplexed and then establishing a session, a second step of collecting the quantity of transmission data when the transmission data is generated, adding a header to the transmission data, and then multiplexing the transmission data and the header, and a third step of transmitting the packet multiplexed through the established session.

### BRIEF DESCRIPTION OF THE DRAWINGS

A more complete appreciation of the present invention, and many of the attendant advantages thereof, will be readily apparent as the same becomes better understood by reference to the following detailed description when considered in conjunction with the accompanying drawings, in which like reference symbols indicate the same or similar components, wherein:

FIG. 1 is a diagram of a PPPmux multiplexing method;

FIG. 2 is a diagram of a CIP or LIPE multiplexing method;

FIG. 3 is a diagram illustrating multiplexing of an application layer in accordance with an embodiment of the present invention;

FIG. 4 is a flowchart illustrating media control for multiplexing an application layer in accordance with an embodiment of the present invention; and

FIG. 5 is a diagram illustrating an SDP used for multiplexing an application layer according to an exemplary embodiment of the present invention.

### DETAILED DESCRIPTION OF EXEMPLARY EMBODIMENTS

The present invention will now be described more fully with reference to the accompanying drawings, in which exemplary embodiments of the invention are shown. Description of functions or configurations related to the present invention that are well- known in the art will be omitted when deemed to detract from the clarity and conciseness of this disclosure.

Embodiments of the present invention described hereinafter are characterized in that multiplexing is performed with respect to transmission data that have no header added. That is, embodiments of the present invention perform multiplexing in a layer which is generally called an application layer.

In the following description of embodiments of the present invention, “transmission data” refers to data to be transmitted via a network without having a header added, and “packet” refers to transmission data to which headers to be transmitted via the network are added. Further, “one transmission unit” in an arbitrary network means the size of the transmission data included in a packet that has not been multiplexed. For example, one transmission unit of a VoIP packet in CDMA 2000 EV-DO system may be 20 bytes.

Further, in the following description, embodiments of the present invention are applied to a communication network having a packet data service configuration, and in particular, are applied to a CDMA 2000 network providing VoIP service. However, the present invention is not limited to such applications, but rather can be applied to any communication network having a packet data service configuration and any communication service provided via such a communication network.

First, an exemplary packet used in the VoIP service will be described in greater detail.

Generally, a packet for a VoIP service (hereinafter referred to as a “VoIP packet”) is transmitted via a packet data network, and the VoIP packet includes Real Time Protocol (RTP) for providing data other than voice data in real time, a User Datagram Protocol (UDP) header of a transmission layer, and an Internet Protocol (IP) header for transmission. These headers are used to properly transmit data in a packet switching scheme. Generally, the VoIP service in a mobile communication network uses optimized Codecs that are capable of generating a small quantity of data compared to Codecs used in wired communication, for the purpose of wireless efficiency. For example, in the case of an Enhanced Variable Rate Codec used in the CDMA 2000 system, a maximum of only 171 bits of data are generated every 20 ms.

As such, the VoIP packet is comprised of voice data to be actually transmitted and headers added thereto. Embodiments of the present invention perform multiplexing with respect to a VoIP packet having such a configuration, in a voice data level rather than the added header level. That is, embodiments of the present invention perform multiplexing in which required number of voice frames are added to the generated voice frame, and then performs packetization in which an IP/UDP/RTP header is added to the multiplexed voice data.

To do this, embodiments of the present invention can comprise a data collector for collecting transmission data in predetermined quantities when the transmission data is generated, and a packet generator for adding a header to the collected transmission data and generating a packet type that can be transmitted via the network. Here, the data collector can be embodied as a buffer, for example. Further, the packet generator can add the header to the multiplexed transmission data received from the data collector in a general manner. According to embodiments of the present invention, the transmission data is multiplexed and then packetized so that overhead can be reduced by an amount corresponding to the header. Hereinafter, embodiments of the present invention will be described in greater detail with reference to the accompanying drawings.

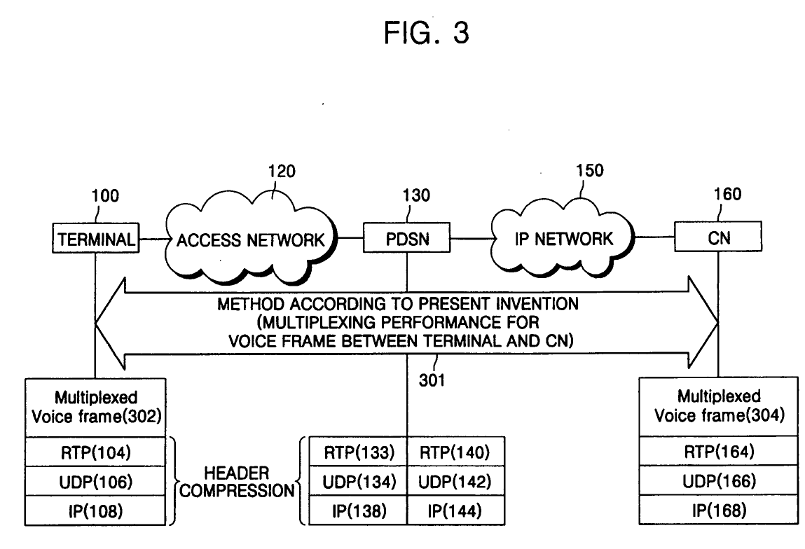

FIG. 3 is a diagram illustrating multiplexing of an application layer in accordance with an embodiment of the present invention.

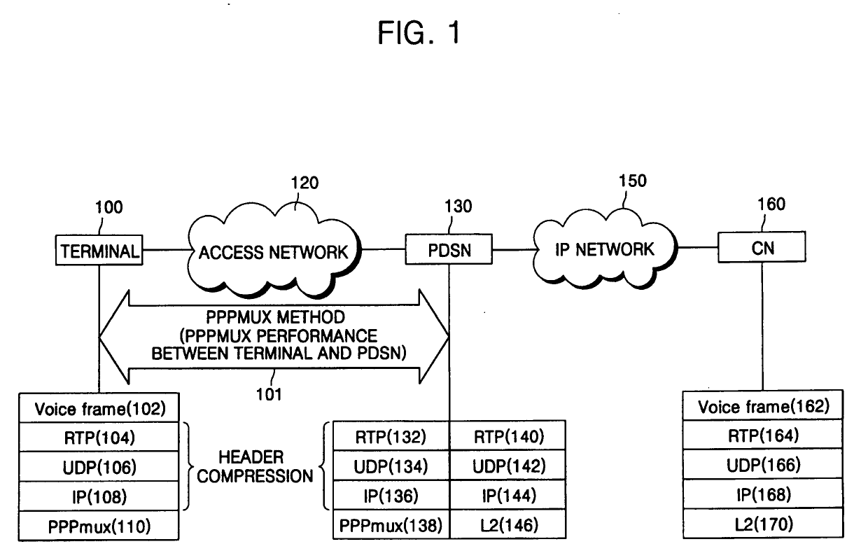

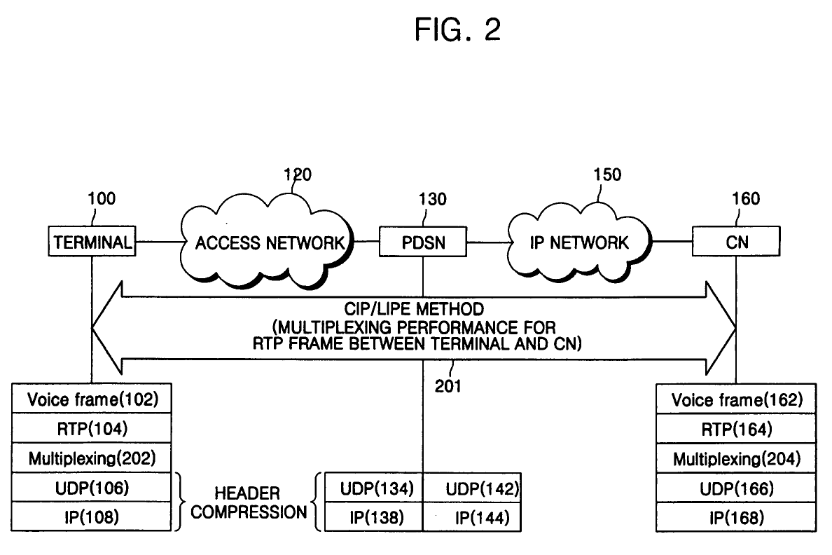

Referring to FIG. 3, a mobile communication network according to an embodiment of the present invention can be comprised of the terminal 100, the access network 120, the packet data switched network 130, the IP network 150, and the correspond node (CN) 160 as described in reference to FIGS. 1 and 2. Multiplexing according to embodiments of the present invention is embodied in a multiplexing method performed between the terminal 100 and the CN 160 as indicated by reference numeral 301. Here, the CN 160 can comprise a multimedia gateway (MGW), a personal computer (PC), a terminal, and so forth. The terminal 100 or the CN 160 multiplexes the transmission data generated, and packetizes and transmits the data to a target terminal or CN.

A protocol stack according to the multiplexing of an application layer is also shown in FIG. 3.

The terminal 100 or CN 160 performs packetization in which the RTP header 104 or. 164, the UDP header 106 or 166, and the IP header 108 or 168, are added to the multiplexed voice frame 302 or 304, respectively, and transmits the packet to the opposite terminal or CN. At this time, the PDSN 130 of the opposite network can process the packets in the same way as non-multiplexed packets.

As shown in FIG. 3, the header can be compressed when transmitting the packet. Header compression is also one method of raising the transmission efficiency of the packet, which reduces the quantity of data transmitted by compressing the header part of the packet. While a detailed description of the compression method is omitted since it is not directly related to embodiments of the present invention, the method typically comprises cRTP (Compressed Real Time Protocol:RFC 3545), ROHC (Robust Header Compression:RFC 3095), and other such compression methods.

The multiplexing is generally performed in consideration of a transmission unit. When an unmultiplexed packet includes transmission data of one transmission unit, a multiplexed packet can include transmission data by a predetermined transmission unit. That is, the multiplexed packet can include transmission data of 2 transmission units and 3 transmission units according to a predetermined establishment. That is, multiplexing of the application layer according to embodiments of the present invention can reduce data quantity to be transmitted by adding the header per transmission data of plural transmission units, rather than by adding the header per transmission data of one transmission unit. In particular, embodiments of the present invention can be more efficiently applied to the packet which has a comparatively large header compared with the transmission data, such as a VoIP packet. Of course, dimensions such as 2 transmission units or 3 transmission units are examples for illustrating embodiments of the present invention, and the data quantity to be multiplexed can be determined in consideration of various conditions such as network environment or the like.

The quantity of transmission data to be multiplexed is determined when establishing a media between network devices to exchange the multiplexed packet. That is, negotiation on how much data is to constitute a unit for multiplexing is performed when establishing the media. At this time, the present invention can be embodied using the SIP/SDP, which is used to establish the existing media without a separate negotiation process or protocol. A method of discussing the number of multiplexing frames required in a signaling process to multiplex the application layer is as follows.

The VoIP service via the mobile communication network will now be described on the basis of an IP Multimedia System (IMS). A signaling protocol in the IMS domain is SIP/SDP through which a call processing function and a discussion process on required information between terminals to communicate are performed. That is, an actual communication provides a service by establishing media according to a result discussed by the SIP/SDP protocols. Here, the SIP provides a function related to call establishment and 5 the SDP includes a bandwidth to be established, media information (Codec information), and so forth. Exemplary information included in the SDP is indicated in Table 1.

TABLE 1

| | | Mandatory (M)/ |
|---|---|---|
| Field | Name | Optional (O) |
| v = | Protocol version number | M |
| o = | Owner/creator and session | M |
| | identifier | |
| s = | Session name | M |
| i = | Session Information | O |
| u = | Uniform Resource Identifier | O |
| e = | Email address | O |
| p = | Phone number | O |
| c = | Connection information | M |
| b = | Bandwidth information | O |
| t = | Time session starts and stops | M |
| r = | Repeat times | O |
| z = | Time zone corrections | O |
| k = | Encryption key | O |
| a = | Attribute lines | O |
| m = | Media information | M |
| a = | Media attributes | O |

Referring to Table 1, it can be understood that the protocol version number, 10 owner/creator and session identifier, session name, connection information, time session starts and stops, and media information are essential fields for SDP, and the remaining fields are optional.

Embodiments of the present invention perform negotiation regarding quantity of transmission data to be multiplexed in order to perform multiplexing in the application layer using a media attribute field that is one of the optional elements. Table 2 below illustrates exemplary attributes which can be included in the media attribute field.

TABLE 2

| Attribute | Name |
|---|---|
| a = rtpmap: | RTP/AVP list |
| a = cat: | Session category |
| a = keywds: | Keywords of session |
| a = tool: | Name of tool used to create SDP |
| a = ptime: | Length of time in milliseconds |
| | for each packet |
| a = recvonly: | Receive only mode |
| a = sendrecv: | Send and receive mode |
| a = sendonly: | Send only mode |
| a = orient: | Orientation for whiteboard session |
| a = type: | Type of conference |
| a = charset: | Character set used for subject and |
| | information fields |
| a = sdplang: | Language for the session description |
| a = framerate: | Maximum video frame rate in frames |
| | per second |
| a = quality: | Suggests quality of encoding |
| a = fmtp: | Format Transport |

Embodiments of the present invention include additional attribute information for multiplexing, in addition to the media attributes shown in Table 2 above.

An attribute added to the attributes of Table 2 to perform multiplexing according to an embodiment of the present invention is “a=mux:<a number of multiplexing frames>”. Using this added attribute field, negotiation about the quantity of transmission data to be multiplexed in the application layer according to embodiments of the present invention is performed. That is, the terminal 100 or the CN 160 negotiates the number of voice frames for multiplexing as well as Codec required from the SDP in an advance call processing procedure to provide a VoIP service using the added attribute field. Contents determined in the negotiation procedure are transmitted after including one of the IP/UDP/RTP header information by multiplexing the contents a corresponding number of times, before generating actual voice media and producing the RTP/UDP/IP packet.

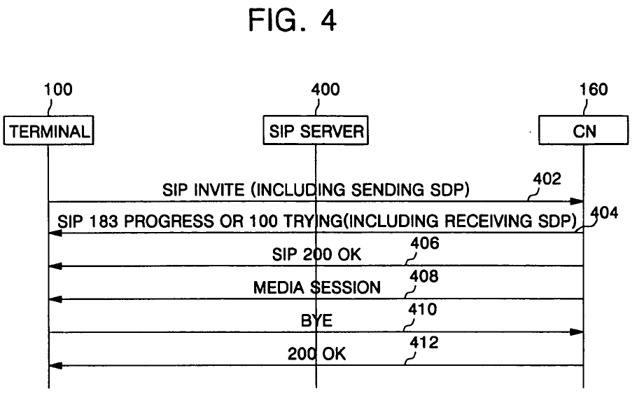

FIG. 4 is a flowchart illustrating media control for multiplexing an application layer in accordance with an embodiment of the present invention.

FIG. 4 illustrates media establishment using SDP including an additional attribute field and data transmission through the established media.

The terminal 100 that wishes to generate a multiplexed packet transfers an INVITE message of the SIP protocol to an SIP server 400 in step 402, and the SIP server 400 requires a call establishment by transferring the INVITE message to the corresponding terminal on the basis of receiving information included in the INVITE message. At this time, the INVITE message includes Codec information of the sending terminal to be established and the number of multiplexed transmission units required in the media attribute of the SDP.

In step 404, the receiving terminal (in this example, CN 160) includes information of comparable receiving contents required by the sending terminal 100 through the SDP information into the SDP, and transmits them to the sending terminal 100. The information is also provided to the sending terminal 100 through the SIP server 400 in the same manner as the INVITE message. Steps 402 and 404 can be repeated until a negotiation between the sending terminal 100 and the receiving terminal 160 is completed.

When the receiving terminal 160 responds to the corresponding VoIP service, it notifies the sending terminal 100 through an SIP 200 OK message in step 406. Media are established according to the result negotiated by the SIP/SDP protocol, and VoIP communication is performed in step 408. At this time, the sending terminal 100 and receiving terminal 160 perform the multiplexing by the number of transmission units determined for the transmission data, namely, voice data, and transmit the data.

In the case of a release of a call, the terminal 100 or 160 which wishes to release the call transmits a BYE message of the SIP protocol to the opposite terminal in step 410. The terminal in receipt of the BYE message from the opposite terminal terminates the corresponding session by transmitting a 200 OK message in response to the BYE message in step 412.

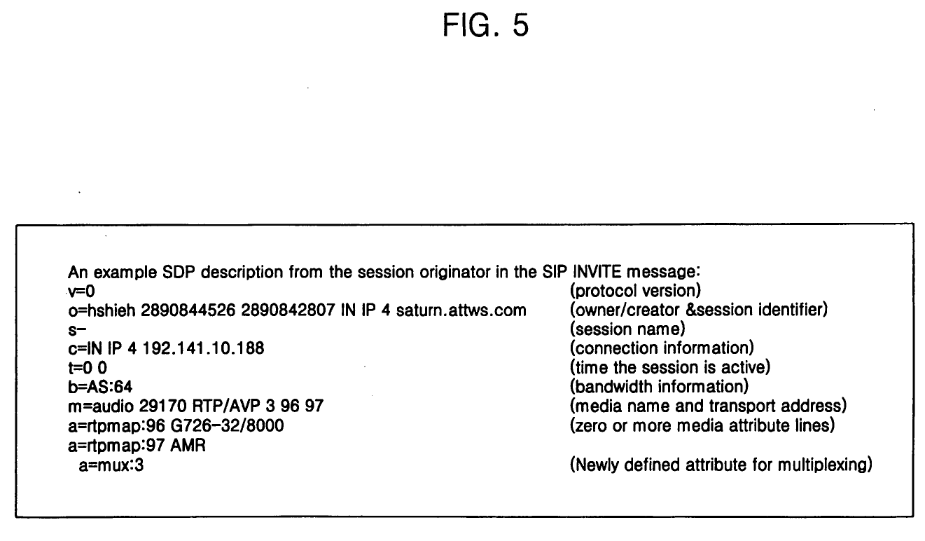

FIG. 5 is a diagram of an exemplary embodiment of the present invention. FIG. 5 illustrates an exemplary embodiment of the SDP used for multiplexing the application layer. Referring to FIG. 5, it can be confirmed that the “a=mux:” field is set as 3. That is, according to an exemplary embodiment of the present invention, transmission data is multiplexed by 3 transmission units and then packetized.

Efficiencies based on each method (specifically overhead) are compared in greater detail below. The following types of overhead are generated in an EV-DO network, with reference to a voice frame of EVRC Codec which generates 20 bytes every 20 ms:
wireless region overhead (RLP and MAC): 6 bytes
PPP overhead between terminal and PDSN: 4-7 bytes (considered to be about 4 bytes)
VoIP packet overhead (RTP/UDP/IP): 40 bytes
   Accordingly, when transmitting without header compression or the multiplexing technique, 70 bytes (50 bytes of overhead+20 bytes of voice data) should be transmitted wirelessly every 20 ms and the required bandwidth is 28 kbps.

Assuming that 4 packets are multiplexed, transmission quantities for each multiplexing method are as follows:
1) PPPmux
; radio(6)+PPP(4)+4*[PPP delimeter(1)+RTP/IP(40)+voice(20)]=254 bytes
   That is, 254 bytes should be transmitted for 80 ms and a wireless capacity of about 25.4 kbps is required.
2) CIP or LIPE
; radio(6)+PPP(4)+UDP/IP(20)+4*[Mux overhead(3)+RTP(20)+voice(20)]=
202 bytes
   That is, 202 bytes should be transmitted for 80 ms and a wireless capacity of about 20.2 kbps is required.
3) Technique usage suggested in the present invention
;radio(6)+PPP(4)+RTP/UDP/IP(40)+4*[voice(20)]=130 bytes
   That is, 130 bytes should be transmitted for 80 ms and a wireless capacity of about 13.0 kbps is required.

The above data indicates that voice frame multiplexing implemented by embodiments of the present invention provide the best efficiency when transmitting the same voice data.

While embodiments of the present invention are described above with reference to VoIP, efficient usage of the wireless region is required in all mobile communication networks as well as the VoIP. Therefore, embodiments of the present invention can be applied to any mobile communication network to enhance packet transmission efficiency.

In contrast, since the wired communication network provides sufficient bandwidth for transmission, powerful techniques for reducing transmission data quantity, such as compression, multiplexing, and so forth, are not needed. However, embodiments of the present invention can be applied to a wired communication network as well as a mobile communication network. Therefore, it is desirable that the wired communication network also determines whether the multiplexing apparatus and method according to embodiments of the present invention is applied based on network requirements.

The multiplexing method in the application layer according to embodiments of the present invention relates to the reduction of the fundamentally generated header, whereby transmission overhead in the transmission section of the network can be minimized and efficiency of the transmission section of a wireless network can be maximized. Further, according to embodiments of the present invention, multiplexing can be performed using existing Session Initiation Protocol/Session Description Protocol (SIP/SDP), without adding a separate signaling procedure.

While the present invention has been described with reference to exemplary embodiments thereof, it will be understood by those skilled in the art that various changes in form and detail may be made therein without departing from the scope of the present invention as defined by the following claims.

What is claimed is:

1. A network multiplexing apparatus used in packet transmission through a network, comprising:
a data collector for collecting a predetermined quantity of transmission data when the transmission data is generated; and
a packet generator for adding a header comprising transmission information within the predetermined quantity of transmission data and generating a packet to be transmitted through the network comprising the predetermined quantity of transmission data.

2. The apparatus according to claim 1, wherein the quantity of transmission data collected is determined using session initiation protocol/session description protocol (SIP/SDP) when establishing a session to be used upon transmission of the packet.

3. The apparatus according to claim 2, wherein the. quantity of transmission data collected is determined through a media attribute field included in the SDP.

4. The apparatus according to claim 1, wherein the transmission data comprises voice data.

5. The apparatus according to claim 1, wherein the transmission data comprises voice over IP(VOID) data.

6. The apparatus according to claim 1, wherein the data collector comprises a buffer for buffering the predetermined quantity of transmission data.

7. The apparatus according to claim 1, wherein the predetermined quantity of transmission data is determined on the basis of one transmission unit.

8. The apparatus according to claim 7, wherein the one transmission unit comprises one transmission unit of the code division multiple access (CDMA) 2000 system.

9. The apparatus according to claim 7, wherein the one transmission unit comprises 20 bytes.

10. The apparatus according to claim 1, wherein the header added to the transmission data by the packet generator comprises real time protocol/user datagram protocol/Internet protocol (RTP/UDP/IP) data.

11. A multiplexing method used in packet transmission through a network, comprising:
a first step of collecting a predetermined quantity of transmission data when the transmission data is generated; and
a second step of adding a header comprising transmission information within the collected transmission data.

12. A multiplexing method used in packet transmission through a network, comprising:
a first step of transmitting, from at least one of a sending terminal and a receiving terminal, session description protocol (SDP) data comprising information on a quantity of transmission data to be multiplexed and then establishing a session;
a second step of collecting the quantity of transmission data when the transmission data is generated, adding a header to the transmission data, and then multiplexing the transmission data and the header; and
a third step of transmitting the packet multiplexed through the established session.

13. The method according to claim 12, wherein the SDP is included in a SIP INVITE message and then transmitted.
